(19) United States
(12) Patent Application Publication
(10) Pub. No.: US 2026/0279846 A1
(43) Pub. Date: Sep. 17, 2026

(54) POROUS TRANSPORT LAYER

(71) Applicant: NV BEKAERT SA, Zwevegem (BE)

(72) Inventors: Thomas FAVET, Zwevegem (BE); Kris SYNHAEVE, Kuurne (BE); Dieter HELLERT, Zwevegem (BE)

(21) Appl. No.: 19/469,132

(22) PCT Filed: Mar. 29, 2024
(86) PCT No.: PCT/EP2024/058771

§ 371 Date: Sep. 25, 2025

(30) Foreign Application Priority Data
Mar. 31, 2023 (EP) 23165851.9

(51) Int. Cl. H01M 8/0232; C25B 9/60; D04H 1/4234; D04H 1/4374; D04H 1/4391; D04H 1/559; H01M 8/10

(52) U.S. Cl. CPC H01M 8/0232; C25B 9/60; D04H 1/4234; D04H 1/4374; D04H 1/43912; D04H 1/559; H01M 8/10; D10B 2505/00

(57) ABSTRACT

A porous transport layer for an electrolyser or for a fuel cell, comprising a first nonwoven layer of metal fibers provided for contacting a proton exchange membrane, wherein the first nonwoven layer of metal fibers comprises metal fibers of a first equivalent diameter, wherein the first nonwoven layer of metal fibers has a first surface roughness and a first porosity, a second nonwoven layer of metal fibers, wherein the second nonwoven layer of metal fibers comprises metal fibers of a second equivalent diameter, wherein the second nonwoven layer of metal fibers has a second surface roughness and a second porosity, wherein the first surface roughness is below 10 μm, the first equivalent diameter is smaller than the second equivalent diameter, the first surface roughness is smaller than the second surface roughness for at least 20%, e.g., in a range of 20% to 120%.

### TECHNICAL FIELD

The invention relates to the field of gas diffusion layers as are e.g., used in electrolysers and fuel cells.

### BACKGROUND ART

Proton exchange membrane (PEM) electrolysers may be used to convert water into separate hydrogen and oxygen streams. Such PEM electrolysers include a polymer electrolyte located between an anode electrode and a cathode electrode. Anode side porous transport layer and cathode side gas diffusion layer are located adjacent to the respective anode and cathode electrodes. A porous metallic, e.g., titanium or titanium alloy, may be used as the anode side porous transport layer.

WO03/059556A2 discloses a stack for use as porous transport layer in a fuel cell or in an electrolyser. The stack comprises an impermeable metal structure, a first metal fiber layer and a second metal fiber layer. The impermeable metal structure is sintered to one side of the first metal fibers layer and the second metal fibers layer is sintered to the other side of the first metal fibers layer. The second metal fiber layer is provided as contact layer to a PEM in a fuel cell or in an electrolyser. The planar air permeability of the stack is more than 0.02 l/min*cm.

A further modified porous transport layer is published in WO2018/189005. The porous transport layer comprises a first nonwoven layer of metal fibers provided for contacting a proton exchange membrane, a second nonwoven layer of metal fibers, and a third porous metal layer. The first nonwoven layer comprises metal fibers of a first equivalent diameter. The second nonwoven layer comprises metal fibers of a second equivalent diameter. The second equivalent diameter is larger than the first equivalent diameter. The third porous metal layer comprises open pores. The open pores of the third porous metal layer are larger than the open pores of the second nonwoven layer of metal fibers. The second nonwoven layer is provided in between and contacting the first nonwoven layer and the third porous metal layer. The second nonwoven layer is metallurgically bonded to the first nonwoven layer and to the third porous metal layer.

The efficiency of a fuel cell system or an electrolyser system is highly affected by the properties of the porous transport layers. WO2020/151997 discloses a porous transport layer based on multiple micro and nano sintered porous layers. The sintered porous layers have a permeability for gaseous and liquid substances in an electrochemical cell, and the multilayer porous transport layer is suited to be assembled between a bipolar plate and a catalyst layer of the electrochemical cell. The multiple micro and nano sintered porous layers are made from irregularly shaped particles of a conductive material. The micro sintered porous layer is made by particles having bigger diameter than the particles in the nano sintered porous layer. The multiple layer structure is achieved by coaxial pressing of multiple irregularly spatted powders where mean particle diameter decreases from layer to layer. The mechanical integrity and specific bulk properties of the porous transport layers are obtained by sintering process.

Another modified porous transport layer is a single layer titanium sheet as disclosed in US2022/0023946. The porous titanium layer that is used as an anode side porous transport layer is formed by a powder process, e.g. tape casting, or by a powder metallurgical technique, in which a titanium powder is pressed into a porous titanium sheet using compaction process. The casted or compacted sheet is then sintered to yield a porous transport layer with an established metallurgical bond. The porous titanium sheet may have a porosity between 40 and 60 percent.

### DISCLOSURE OF INVENTION

The first aspect of the invention is a porous transport layer for an electrolyser or for a fuel cell, comprising
a first nonwoven layer of metal fibers provided for contacting a proton exchange membrane, wherein the first nonwoven layer of metal fibers comprises metal fibers of a first equivalent diameter,
wherein the first nonwoven layer of metal fibers has a first surface roughness and a first porosity,
a second nonwoven layer of metal fibers, wherein the second nonwoven layer of metal fibers comprises metal fibers of a second equivalent diameter, wherein the second nonwoven layer of metal fibers has a second surface roughness and a second porosity,
wherein the first surface roughness is below 10 μm,
the first equivalent diameter is smaller than the second equivalent diameter,
the first surface roughness is smaller than the second surface roughness for at least 20%, e.g., in a range of 20% to 120%;
wherein the first porosity is smaller than the second porosity for at least 10%, e.g., in a range of 10%-50%; and
wherein the first nonwoven layer is metallurgically bonded to the second nonwoven layer.

The first and second surface roughness are average surface roughness (Ra) and measured according to standard ASME B46.1.

The first nonwoven layer is provided to act as contact layer to anode electrode side. It is beneficial that the first porosity is smaller than the second porosity for at least 10%. The higher porosity side, i.e., second nonwoven layer of metal fibers of the porous transport layer is to be oriented towards the flow plate side of an electrolyser or a fuel cell. Thus, the high porosity permits more water to enter the pores. While the lower porosity side of i.e., first nonwoven layer of metal fibers of the porous transport layer is to be oriented towards anode electrode side of an electrolyser or a fuel cell. Thus, the low porosity provides an improved electrical contact with the anode electrode. According to the present invention, the porous transport layer comprises two layers having different porosity. Preferably, the two layers also have different pore size. Importantly, the first nonwoven layer is metallurgically bonded to the second nonwoven layer. Therefore, the porous transport layer made from the first nonwoven layer and the second nonwoven layer behaves like an assembly. Thus, the porosity at each side and overall porosity of the porous transport layer can be well controlled by an assembly of two separate layers. This is beneficial compared with the single layer porous transport layer as in US2022/0023946, where the first major side the porous titanium sheet has a porosity which is at least 10 percent higher than the second major opposite second side. This is also beneficial compared with WO2018/189005 and WO2020/151997, where disclose a porous transport layer based on multiple sintered porous layers, because the porosity of each layer in those multiple sintered porous layers are similar resulting from single sintering process.

In addition, the first surface roughness is smaller than the second surface roughness for at least 20%, e.g., in a range of 20% to 120%; and the first surface has an average roughness below 10 μm measured by standard ASME B 46.1, preferably below 8 μm and more preferably below 5 μm. PEM electrolysers typically have a catalyst coated membrane. The catalysts coated on the membrane are Platinum (Pt) at the cathode side and Irridium oxide (IrOx) at the anode side. The scarcity of Ir is very concerning for the development of PEM. Global Ir production rate is about 7 ton/year. At current catalyst loadings (2 mg/cm²), the annual installation of PEM electrolysers would be limited to 2 GW. Unfortunately, there are no alternative catalyst for the oxygen evolution reaction (anode side) that can compete with Ir, due to its high stability and efficiency. Without any competitive alternative, research is focused on reducing Ir catalyst loading significantly while keeping the same performance. To maintain acceptable performances, the catalyst needs to be in close contact with the porous transport layer (e− path) and the ionomer (H+ path). With low loading of Ir, implying a thinner layer of catalyst, the contact with the porous transport layer will be reduced. In addition, Ir particles tend to agglomerate, which should also negatively affect the contact with the porous transport layer, and therefore lead to poor performances due to a bad catalyst utilization.

In addition to reduce the catalyst loading, the trend in PEM electrolyser is to decrease the thickness of the membrane, to reduce the overpotential and enhance the overall performances. This trend brings some challenges regarding the mechanical properties at the interface of porous transport layer/anode/membrane. Indeed, the membrane is a fragile component of the PEM cell, and a bad contact with the porous transport layer/anode could lead to the puncture of the membrane, with a strong risk of short circuit within the cell.

To bring a solution to these issues, the inventive porous transport layer having a first nonwoven layer with a roughness below 10 μm can be used to enhance the contact with the Ir particles and prevent the puncture of the membrane.

The microstructure of this first nonwoven layer should be finer and denser than the second nonwoven layer, with a small inter-particle distance, to ensure a close contact with the catalyst layer. This also provides a more homogeneous repartition of the forces applied to the membrane and prevent its mechanical degradation. The surface roughness of the first layer is smaller than the surface roughness of the second layer for at least 20%, e.g., in a range of 20% to 120%. The low surface roughness of first layer is intended to avoid puncture phenomenon.

The second nonwoven layer is metallurgically bonded to the first nonwoven layer. Metallurgical bonding can e.g., be performed by means of sintering or by means of welding (e.g., by means of capacitive discharge welding, CDW). Preferably, the metal fibers in the first nonwoven layer are metallurgically bonded to each other. Preferably, the metal fibers in the second nonwoven layer are metallurgically bonded to each other.

The presence of the first nonwoven layer of metal fibers may negatively affect the inflow and outflow of molecules through the plane and may consequently negatively affect the functionality of the electrolyser or fuel cell as the reduced flow increase the required overvoltage of the electrolyser. The metallurgical bonds between the layers are important, as such bonds provide for a low electrical resistance between the layers. Providing a reliable metallurgical bonding between the first nonwoven layer and the second nonwoven layer is desirable. The benefit is a reduced ohmic resistance of the porous transport layer, reducing the overvoltage of the electrolyser, and an improved mechanical stability of the porous transport layer. There is inevitably a certain amount of hairiness on the surface of both nonwovens. Consequently, fibers from the first nonwoven will penetrate to a certain extent in the second nonwoven, and metal fibers of the second nonwoven will penetrate to a certain extent in the first nonwoven. The penetrations create enhanced metallic contacts and metallurgical bonding, both beneficial for the reduced ohmic resistance of the porous transport layer, reducing the overvoltage of the electrolyser, and an improved mechanical stability of the porous transport layer.

With equivalent diameter of a fiber is meant the diameter of a circle having the same surface area as the cross section of a fiber which does not necessarily has a circular cross section.

The pore size of the nonwoven layers can be observed in several ways. A cross section through the thickness of the porous transport layer can be made, and the cross section can be analysed under a microscope, in which the pores—and their sizes—become visible. A more advanced method is X-ray tomography of the porous transport layer. Alternatively, the pore size can be measured by mercury porosimetry.

According to the present invention, the first equivalent diameter can be less than 20 μm and preferably less than 15 μm. The use of the fine fibers is beneficial, as a large contact area with the PEM is provided for the electrochemical reaction to take place; and the fine pores-present because of the use of the fine fibers in the first nonwoven layer-allow capillarity for efficient mass transport to and from the reaction sites at the PEM. The second equivalent diameter is preferably less than 50 μm, and more preferably less than 30 μm. The second equivalent diameter is preferably bigger than the first equivalent diameter. As an example, the first equivalent diameter is 14 μm and the second equivalent diameter is 22 μm. The second nonwoven layer of metal fibers has bigger diameter and thus the pores in the second nonwoven layer is bigger than the pores in the first nonwoven layer. As an example, the first nonwoven layer has a porosity in a range of 30 to 50%, preferably in a range of 40 to 50%, the second nonwoven layer has a porosity in a range of 51 to 90% and the overall porosity of the porous transport layer is in a range of 50 to 80%. The positive consequence is an efficient planar mass inflow and outflow. Preferably, the thickness of the first nonwoven layer is less than 100 μm. Such embodiment provides a particularly beneficial porous transport layer, as the first nonwoven layer that provides the contact layer with the PEM is thin, such that in the available space for the provision of the porous transport layer in the electrolyser, a larger thickness of the second nonwoven layer can be provided; the second nonwoven layer that provides for the in-plane inflow and outflow of water and reaction products.

More preferably, the thickness of the second nonwoven layer is at least double the thickness of the first nonwoven layer. The planar flow is thus further improved thanks to the thickness of the second nonwoven layer, thereby providing a large cross section for planar mass flow.

Preferably, the first nonwoven layer and the second nonwoven layer comprise—and more preferably consist out of—titanium fibers. Alternatively, the first and second nonwoven layer can be made from titanium alloy fibers, nickel fibers, nickel alloy fibers or stainless-steel fibers.

In a preferred embodiment, the metal fibers of the first nonwoven layer and/or of the second nonwoven layer have a discrete length; and have a cross section, wherein the cross section has two neighboring straight lined sides with an included angle of less than 90 degrees and one or more irregularly shaped curved sides. The metal fibers of the first nonwoven layer have a large surface area thanks to the irregular shape of their cross section. The consequence is a large surface area in contact with the proton exchange membrane on which the electrochemical reaction can take place, especially when the surface of the first nonwoven layer is coated with catalyst or when the proton exchange membrane is coated with catalyst. Such fibers can be made as described in WO2014/048738A1. Another technology for producing such fibers is described in U.S. Pat. No. 4,640,156.

Alternatively, the metal fibers of the second nonwoven layer have a quadrangular, and preferably a rectangular cross section. A technology for manufacturing such fibers is disclosed in U.S. Pat. No. 4,930,199. This provides a benefit: the metal fibers of the second nonwoven layer have a more compact cross section, which does not create obstructions for the planar inflow and outflow of gases in the electrolyser or fuel cell in which the porous transport layer is used.

As an example, the second nonwoven layer may further comprise one or more expanded metal sheets or woven wire meshes; wherein the expanded metal sheets or woven wire meshes are metallurgically bonded to each other, e.g., by means of sintering or by means of welding, e.g., capacitive discharge welding (CDW). It is a benefit that expanded metal sheets have a higher stiffness than sintered nonwovens. The porous transport layer of the invention may further comprise a third porous metal layer having bigger pore size and/or porosity adjacent to the second nonwoven layer of metal fibers. A multilayer porous transport layer including one or more expanded metal sheets allows a high surface area at the PEM side, while the stiffness prevents sagging when compressed against a profiled surface provided by a bipolar plate in which flow channels have been machined.

A second aspect of the invention is another method of making a porous transport layer for an electrolyser or for a fuel cell as in any of the preceding claims, comprising the steps of, and preferably in the order of:
(a) making a first nonwoven layer of metal fibers,
(b) sintering the first nonwoven layer of metal fibers to have a sintered first nonwoven layer of metal fibers, e.g., in an oxygen-free or low oxygen atmosphere at 1000 to 1200 degrees Celsius for 1 to 2 hours, preferably under load of 70 kg/m² to 200kg/m²,
(c) compressing the sintered first nonwoven layer of metal fibers to have a compressed sintered first nonwoven layer of metal fibers,
(d) making a second nonwoven layer of metal fibers,
(e) stacking the compressed sintered first nonwoven layer of metal fibers with the second nonwoven layer of metal fibers to form a dual layer structure,
(f) sintering the dual layer structure, e.g., in an oxygen-free or low oxygen atmosphere at 1000 to 1200 degrees Celsius for 1 to 2 hours, preferably under load of 70 kg/m² to 200kg/m²,
(g) optionally compressing the sintered dual layer structure to a determined thickness.

The first nonwoven layer of metal fibers is compressed after sintering. Preferably, the compression is applied under a load force of 30 to 80 kN/mm², e.g. 60 kN/mm². The applied compressing step (c) before the second sintering of first nonwoven layer, i.e. sintering the dual layer (f), has brought significant advantage with respect to reduce surface roughness and control the porosity of the first nonwoven layer. The formed dual layer porous transport layer according to the invetnon has a top surface with low porosity and roughness, which is desirable for its application.

A third aspect of the invention is a stack for an electrolyser or a fuel cell, comprising a porous transport layer as in the first aspect of the invention, and a bipolar plate. The bipolar plate contacts the second nonwoven layer. Preferably, the bipolar plate is metallurgically bonded to the second nonwoven layer, e.g., by means of sintering or welding. Preferably, the bipolar plate is flat over its entire surface that is contacting the second nonwoven layer; meaning that no flow fields are provided in the bipolar plate.

A fourth aspect of the invention is an assembly of a porous transport layer as in the first aspect of the invention and a proton exchange membrane. The first nonwoven layer contacts the proton exchange membrane. Preferably a catalyst is provided on the first nonwoven layer at the side where the first nonwoven layer contacts the proton exchange membrane, or a catalyst is provided on the proton exchange membrane at the side in contact with the first nonwoven layer.

A fifth aspect of the invention is an assembly of a stack as in the third aspect of the invention and a proton exchange membrane. The first nonwoven layer contacts the proton exchange membrane. Preferably a catalyst is provided on the first nonwoven layer at the side where the first nonwoven layer contacts the proton exchange membrane, or a catalyst is provided on the proton exchange membrane at the side in contact with the first nonwoven layer.

### BRIEF DESCRIPTION OF THE FIGURES

FIG. 1(a) shows schematically a cross section of a porous transport layer according to the invention; FIG. 1(b) shows a magnified picture of the cross section of a porous transport layer according to the invention.

FIG. 2 shows a comparison of pore sizes of a porous transport layer according to the invention with a monolayer porous transport layer.

FIG. 3 shows a comparison of average surface roughness of a porous transport layer according to the invention with a monolayer porous transport layer.

FIG. 4 compares the electrical resistance at compression through the thickness of a porous transport layer according to the invention with a monolayer porous transport layer.

### MODE(S) FOR CARRYING OUT THE INVENTION

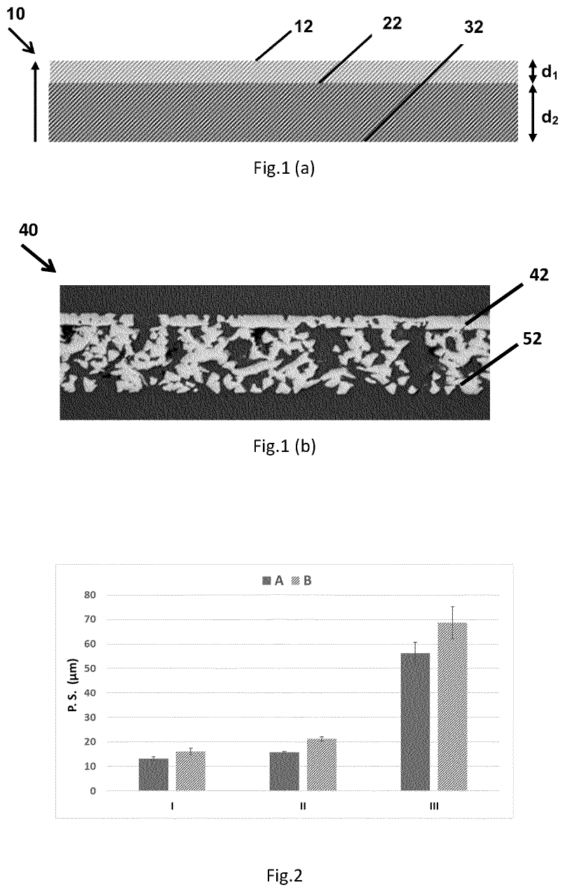

An exemplary porous transport layer 10 according to the invention is schematically shown in FIG. 1(a). A magnified picture of the cross section of this exemplary porous transport layer 40 is shown in FIG. 1(b). The exemplary porous transport layer 10, 40 consists of a first nonwoven layer 12, 42 of titanium fibers and a second nonwoven layer 22, 52 of titanium fibers. The first nonwoven layer 12, 42 of titanium fibers is provided for contacting a proton exchange membrane in an electrolyser. The first nonwoven layer of titanium fibers comprises titanium fibers of 14 μm equivalent diameter. The titanium fibers of the first nonwoven layer have 10 mm length, and have a cross section, wherein the cross section has two neighbouring straight-lined sides with an included angle of less than 90 degrees and one or more irregularly shaped curved sides. The first nonwoven layer has a thickness d1 about 40 μm. The first nonwoven layer has a porosity of 43%. The second nonwoven layer 22, 52 of titanium fibers consists of 400 g/m² of titanium fibers with an equivalent diameter 22 μm. The thickness d2 of the second nonwoven layer is about 200 μm. The second nonwoven layer has a porosity of 78%. The overall porosity of the porous transport layer consisting of the first and second nonwoven layers has a porosity of about 56%. Because of the larger equivalent diameter of fibers in the second nonwoven layer compared to the first nonwoven layer, the open pores are larger in the second nonwoven layer than those in the first nonwoven layer.

Such a porous transport layer can be made according to the steps of, preferably in order:
(a) making a first nonwoven layer of titanium fibers,
(b) sintering the first nonwoven layer of titanium fibers to have a sintered first nonwoven layer of titanium fibers, e.g., in an oxygen-free or low oxygen atmosphere at 1000 to 1200 degrees Celsius for 1 to 2 hours, preferably under a load of 70 kg/m² to 200kg/m²,
(c) compressing the sintered first nonwoven layer of titanium fibers to have a compressed sintered first nonwoven layer of titanium fibers,
(d) making a second nonwoven layer of titanium fibers,
(e) stacking the compressed sintered first nonwoven layer of titanium fibers with the second nonwoven layer of titanium fibers to form a dual layer structure,
(f) sintering the dual layer structure, e.g., in an oxygen-free or low oxygen atmosphere at 1000 to 1200 degrees Celsius for 1 to 2 hours, preferably under a load of 70 kg/m² to 200kg/m²,
(g) compressing the sintered dual layer structure to a determined thickness.

The exemplary porous transport layer according to the invention has been compared with a reference standard monolayer porous transport layer. The reference porous transport layer having a similar thickness of the inventive porous transport layer is made from titanium fibers with equivalent diameter 22 μm and has a porosity of 56%.

The pore size of the inventive porous transport layer and the reference porous transport layer are measured and analyzed. The pore size distribution is analyzed based on minimum pore (I), mean pore (II) and maximum pore (III). As illustrated in FIG. 2, in all the range, i.e., for the minimum pore, the mean pore and the maximum pore, the size of the inventive porous transport layer (A in FIG. 2) is significantly reduced compared with the reference porous transport layer (B in FIG. 2), thanks to the densified first nonwoven layer. The smaller pore size distribution can be translated to a smaller inter-particle distance, which should lead to a better contact with the catalyst layer.

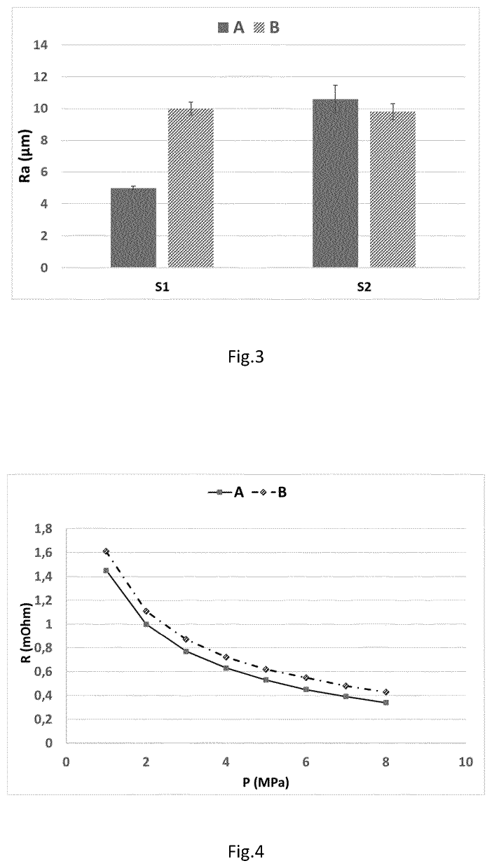

In addition, the average surface roughness of the inventive porous transport layer and reference porous transport layer are measured. Two sides (S1, S2) of the inventive porous transport layer (A in FIG. 3) and reference porous transport layer (B in FIG. 3) are evaluated and compared in FIG. 3. Side S1 of the inventive porous transport layer is a surface of the first nonwoven layer made from titanium fibers of 14 μm equivalent diameter (12 in FIG. 1), while S2 of the inventive porous transport layer is a surface of the second nonwoven layer made from titanium fibers of 22 μm equivalent diameter (32 in FIG. 1). The average surface roughness (Ra) measured according to standard ASME B46.1 is shown in Y-axis (in um). As shown in FIG. 3, one side (S2) roughness of the inventive porous transport layer and the reference porous transport layer is rather comparable. Another side (S1) roughness of the inventive porous transport layer (5.0 μm) is significantly decreased compared with the roughness of the reference porous transport layer (10.0 μm). The side with lower roughness of the inventive porous transport layer (S1) is intended to contact with catalyst, while the other side (S2) is intended to contact with bipolar plate. Using the inventive porous transport layer, it should be beneficial to prevent the puncture of the membrane.

The electrical resistance has been measured through the thickness of the porous transport layer, as a function of the compressive forces on the porous transport layer. Porous transport layers operate in electrolysers and in fuel cells under compressive forces, e.g., under 4 MPa or even under higher compressive forces. FIG. 4 shows in Y-axis (in mOhm) the measured electrical resistance at compression through the thickness of the inventive porous transport layer (curve A) and of the reference porous transport layer (curve B), as a function of the compressive forces on the inventive porous transport layer or reference porous transport layer (in X-axis, compressive forces or pressure P expressed in MPa). The measured samples of the inventive porous transport layer and the reference porous transport layer had a same dimension, and they were measured at same condition. The results show a slightly reduced electrical resistance through the inventive porous transport layer under compressive forces as used in an electrolyser or in a fuel cell (curve A) compared with the reference porous transport layer (curve B). The inventive porous transport layer would lead to a reduction of the ohmic overpotential at the interface of the porous transport layer and catalyst. In addition, it is clearly indicated that the deformation of porous transport layer made from fibers is mainly elastic, which is perceived to be a clear advantage for the application, in comparison with plastic deformation of powder-based porous transport layer.

1. A porous transport layer for an electrolyser or for a fuel cell, comprising
a first nonwoven layer of metal fibers provided for contacting a proton exchange membrane, wherein the first nonwoven layer of metal fibers comprises metal fibers of a first equivalent diameter,
wherein the first nonwoven layer of metal fibers has a first surface roughness and a first porosity,
a second nonwoven layer of metal fibers, wherein the second nonwoven layer of metal fibers comprises metal fibers of a second equivalent diameter, wherein the second nonwoven layer of metal fibers has a second surface roughness and a second porosity,
wherein the first surface roughness is below 10 μm,
the first equivalent diameter is smaller than the second equivalent diameter, the first surface roughness is smaller than the second surface roughness for at least 20%, e.g., in a range of 20% to 120%,
wherein the first porosity is smaller than the second porosity for at least 10%, e.g., in a range of 10%-50%, and
wherein the first nonwoven layer is metallurgically bonded to the second nonwoven layer.

2. The porous transport layer as in claim 1, wherein the thickness of the second nonwoven layer is at least double the thickness of the first nonwoven layer.

3. The porous transport layer of claim 1, wherein the first equivalent diameter is less than 20 μm.

4. The porous transport layer of claim 1, wherein the second equivalent diameter is bigger than the first equivalent diameter, and less than 50 μm.

5. The porous transport layer of claim 1, wherein the first equivalent diameter is 14 μm and the second equivalent diameter is 22 μm.

6. The porous transport layer of claim 1, wherein the thickness of the first nonwoven layer is less than 100 μm.

7. The porous transport layer of claim 1, wherein the first nonwoven layer and the second nonwoven layer comprise, and preferably consist of any one of titanium fibers, nickel fibers, or stainless-steel fibers.

8. The porous transport layer of claim 1, wherein the metal fibers of the first nonwoven layer have a discrete length, and have a cross section, wherein the cross section has two neighbouring straight-lined sides with an included angle of less than 90 degrees and one or more irregularly shaped curved sides.

9. The porous transport layer of claim 1, wherein the first nonwoven layer has a porosity in a range of 30 to 50%, the second nonwoven layer has a porosity in a range of 51 to 90% and the overall porosity of the porous transport layer is in a range of 50 to 80%.

10. The porous transport layer of claim 1, wherein said porous transport layer further comprise a third porous metal layer having bigger pore size and/or porosity adjacent to the second nonwoven layer of metal fibers.

11. A method of making a porous transport layer for an electrolyser or for a fuel cell as in claim 1, comprising the steps of:
(a) making a first nonwoven layer of metal fibers,
(b) sintering the first nonwoven layer of metal fibers to have a sintered first nonwoven layer of metal fibers,
(c) compressing the sintered first nonwoven layer of metal fibers to have a compressed sintered first nonwoven layer of metal fibers,
(d) making a second nonwoven layer of metal fibers,
(e) stacking the compressed sintered first nonwoven layer of metal fibers with the second nonwoven layer of metal fibers to form a dual layer structure,
(f) sintering the dual layer structure,
(g) optionally compressing the sintered dual layer structure to a determined thickness.

12. The method of making a porous transport layer as in claim 11, wherein in step (c), the compression is applied under a load force of 30 to 80 kN/mm².

13. A stack for an electrolyser or a fuel cell, comprising
a porous transport layer as in claim lany and
a bipolar plate,
wherein the bipolar plate contacts the second nonwoven layer, preferably wherein the bipolar plate is metallurgically bonded to the second nonwoven layer.

14. An assembly of a porous transport layer of claim 1, and a proton exchange membrane; or assembly of a stack for an electrolyser or a fuel cell and a proton exchange membrane;
wherein the first nonwoven layer contacts the proton exchange membrane; and
preferably wherein a catalyst is provided on the first nonwoven layer at the side where the first nonwoven layer contacts the proton exchange membrane.
